(19) United States
(12) Patent Application Publication
(10) Pub. No.: US 2016/0356240 A1
(43) Pub. Date: Dec. 8, 2016

(54) REMANUFACTURED CYLINDER BLOCK FOR INTERNAL COMBUSTION ENGINE

(71) Applicant: Caterpillar Inc., Peoria, IL (US)

(72) Inventors: Daniel T. Cavanaugh, Chillicothe, IL (US); Nguyenbao H. Chu, Dunlap, IL (US); Curtis J. Graham, Peoria, IL (US); Justin C. Embrey, Morton, IL (US); Kevin P. Reardon, Peoria, IL (US); Bharat K. Meduru, Dunlap, IL (US)

(73) Assignee: Caterpillar Inc., Peoria, IL (US)

(21) Appl. No.: 15/238,499

(22) Filed: Aug. 16, 2016

(51) Int. Cl. F02F 1/00

(52) U.S. Cl. CPC F02F 1/004; F02F 2200/00

(57) ABSTRACT

A cylinder block of an engine is provided. The cylinder block includes a top deck. The cylinder block also includes a cylindrical surface defining a bore extending from the top deck along a longitudinal axis. The cylinder block includes a shoulder portion formed on the top deck. The top deck includes an abutment surface. The cylinder block further includes an insert disposed in the shoulder portion. The insert includes an outer surface adapted to fuse with the abutment surface of the shoulder portion. A predetermined force and a predetermined electric current are applied to the insert for fusing the outer surface of the insert with the abutment surface of the shoulder portion.

### TECHNICAL FIELD

The present disclosure relates to internal combustion engines, and more particularly to a remanufactured cylinder block for an internal combustion engine.

### BACKGROUND

Various components of an engine such as a cylinder block, pistons, a cylinder head, and cylinder bores are subjected to loads and abrasion during operation of the engine. The cylinder block experiences loads during combustion events occurring within combustion chambers defined by the cylinder head, the pistons, and the cylinder bores. The combustion events and prolonged operation of the engine may subject the cylinder block to loads and abrasion, thereby causing wear on one or more surfaces of the cylinder block.

For example, wear may take place on the cylinder block at a deck surface, proximal to the cylinder bore. Such cylinder blocks are generally remanufactured by machining worn-out portions of the cylinder blocks and installing inserts in machined portions. Typically, the inserts are press-fitted on the machined portions of the cylinder block. However, press-fitting of the inserts often provides an ineffective sealing between the cylinder bore and the deck surface of the cylinder block. This may lead to leakage of coolant circulating between a cylinder liner and the cylinder bore to the deck surface of the cylinder block. Eventually, leakage of the coolant to the deck surface may further lead to corrosion of the inserts and the cylinder block.

U.S. Pat. No. 5,566,654, hereinafter referred to as '654 patent, discloses a cylinder head arrangement for an engine such as a diesel engine that includes a pre-combustion chamber. The pre-combustion chamber is formed primarily by a recess formed in the main combustion chamber and an insert piece that is interlocked in any of a variety of different matters to the cylinder head casting. Various arrangements for achieving the interlocked are disclosed and these include pressing and/or welding. However, the cylinder head arrangement of '654 fails to address the problem associated with leakage of coolant from a cylinder bore to a deck surface of a cylinder block.

### SUMMARY OF THE DISCLOSURE

In one aspect of the present disclosure, a cylinder block of an engine is provided. The cylinder block includes a top deck. The cylinder block also includes a cylindrical surface defining a bore extending from the top deck along a longitudinal axis. The cylinder block includes a shoulder portion formed on the top deck. The top deck includes an abutment surface. The cylinder block further includes an insert disposed in the shoulder portion. The insert includes an outer surface adapted to fuse with the abutment surface of the shoulder portion. A predetermined force and a predetermined electric current are applied to the insert for fusing the outer surface of the insert with the abutment surface of the shoulder portion.

In another aspect of the present disclosure, a method of remanufacturing a cylinder block of an engine is provided. The method includes forming an abutment surface on a top deck of the cylinder block, and disposing an insert on the abutment surface. The method further includes applying a predetermined force on the insert along a predefined direction. The method further includes applying a predetermined electric current to the insert for fusing an outer surface of the insert with the abutment surface of the cylinder block.

Other features and aspects of this disclosure will be apparent from the following description and the accompanying drawings.

### BRIEF DESCRIPTION OF THE DRAWINGS

FIG. 1 is a partial exploded view of an cylinder block of an engine, according to an embodiment of the present disclosure;

FIG. 2 is a partial perspective view of the cylinder block of FIG. 1;

FIG. 3 is a partial sectional view of the cylinder block taken along line A-A′ of FIG. 2;

FIG. 4 is a schematic view of a joining device connected to an insert and the cylinder block; and

FIG. 5 is a flowchart of a method for remanufacturing the cylinder block, according to an embodiment of the present disclosure.

### DETAILED DESCRIPTION

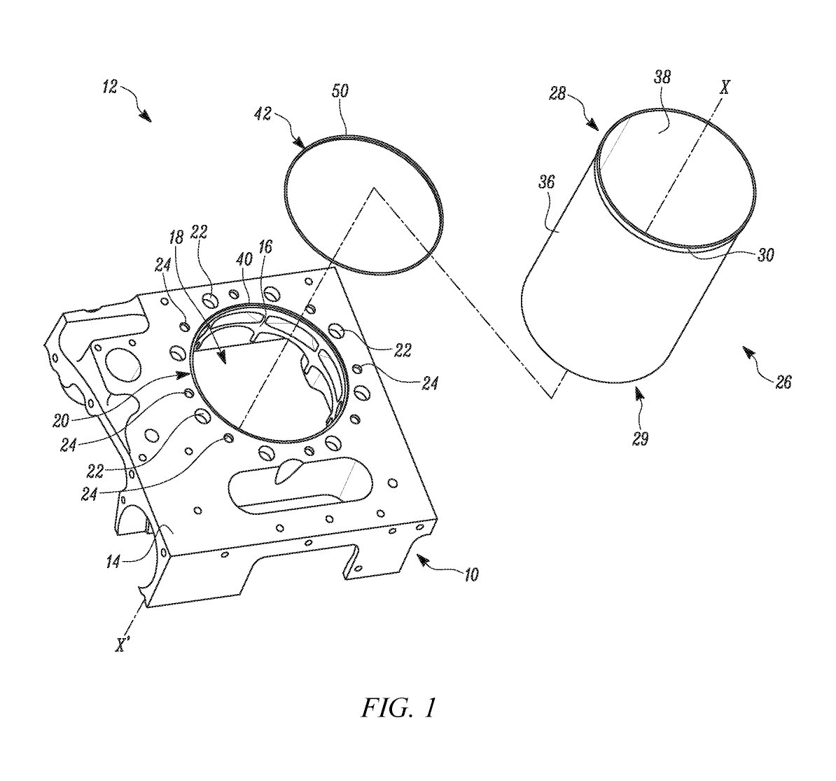

Referring to FIG. 1, an engine 12 includes a cylinder block 10. The engine 12 is embodied as a compression ignition engine. In various examples, the engine 12 may be any type of engine, such as an internal combustion engine run by gasoline, diesel, gaseous fuel, or a combination thereof. The engine 12 may be used as a source of power for any machine, such as ships, on-highway trucks, off-highway trucks, and earth moving equipment, and various devices, such as pumps, stationary equipment, and generators. The engine 12 may also be used to power machines or devices in construction, transportation, power generation, aerospace applications, locomotive applications, marine applications, and any other applications that require a rotary power.

Although not shown, the engine 12 may include, but is not limited to, a cylinder head (not shown) disposed on the cylinder block 10, a front cover (not shown), and an oil pan (not shown) coupled to the cylinder block 10. In an example, the cylinder block 10 may be made of cast iron, aluminum alloys, or any other material known in the art.

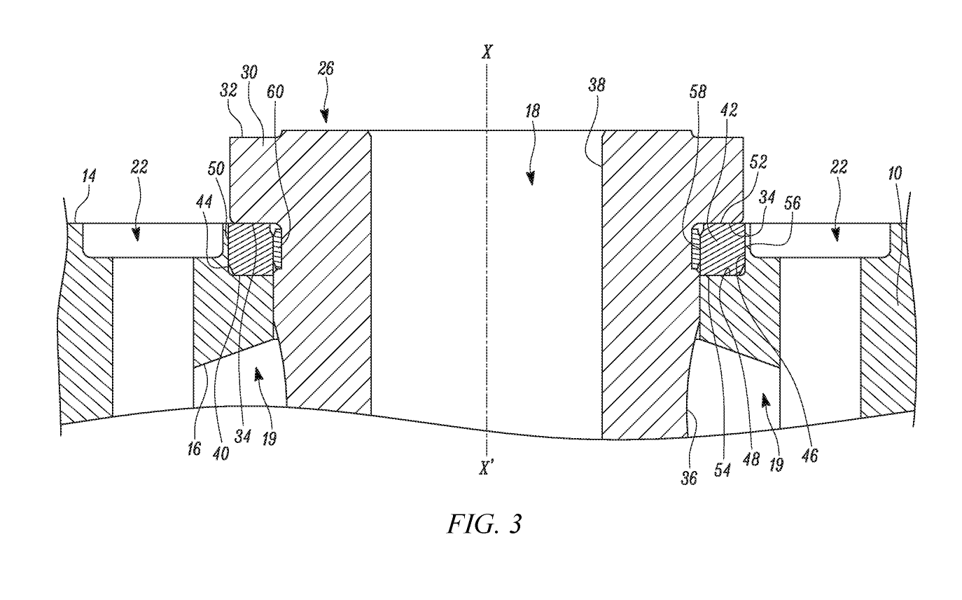

The cylinder block 10 includes a top deck 14. The cylinder block 10 further includes a cylindrical surface 16 defining a bore 18 extending from the top deck 14 along a longitudinal axis X-X′. The bore 18 is a cylinder bore of the engine 12. The bore 18 includes a top end 20 and a bottom end (not shown) distal from the top end 20. Further, a number of cavities 19 (shown in FIG. 3) may be defined on the cylindrical surface 16 of the cylinder block 10. The cavities 19 are provided to receive fluid, such as coolant, therein. Although, the cylinder block 10 shown in the accompanying figures includes one bore, it should be understood that the cylinder block 10 of the engine 12 may include more than one bore arranged in any type of configuration, such as an inline configuration, a V-type configuration, and a radial configuration.

Referring to FIG. 1, the top deck 14 of the cylinder block 10 includes a number of openings, such as a number of fluid passages 22, and a number of fastening bores 24. The fluid passages 22, also referred to as water ferrules, are circumferentially distributed around the bore on the top deck 18 of the cylinder block 10. Each of the fluid passages 22 is equally spaced apart from each other. The fluid passages 22 are in fluid communication with the number of cavities 19 defined on the cylindrical surface 16. The fluid passages 22 extend from the top deck 14 along the longitudinal axis X-X′ of the bore 18. The fluid passages 22 are provided for circulating the fluid within the cylinder block 10 and to the cylinder head, thereby cooling the cylinder block 10 and the cylinder head during operation of the engine 12.

The fastening bores 24 are provided for fastening the cylinder head with the cylinder block 10. The fastening bores 24 receive a number of fastening bolts (not shown) for fastening the cylinder head with the cylinder block 10. The bore 18 is covered by the cylinder head, thus creating a combustion chamber therein. In an example, the cylinder head may provide a structure for supporting intake and exhaust valves and/or ports, fuel injectors, necessary linkages, and/or other devices known in the art.

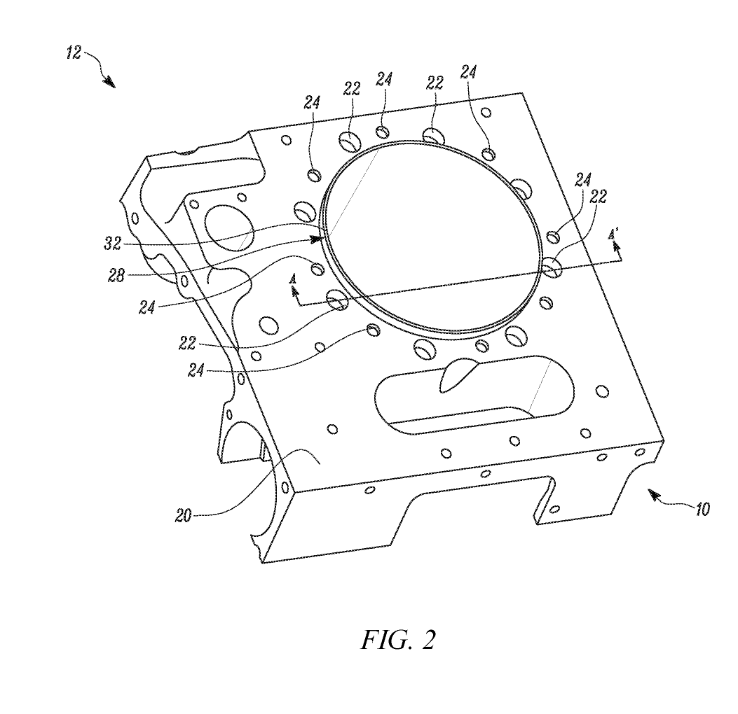

The bore 18 accommodates a cylinder liner 26. More specifically, the bore 18 receives the cylinder liner 26 along the longitudinal axis X-X′. The cylinder liner 26 is removably disposed within the bore 18 of the cylinder block 10. The cylinder liner 26 includes a first end 28 and a second end 29. The first end 28 includes a flange portion 30 having a first annular surface 32 (shown in FIG. 2) and a second annular surface 34 (shown in FIG. 3). The cylinder liner 26 also includes a surface 36 and a surface 38 distal to the surface 36.

Referring to FIGS. 1, 2 and 3, the cylinder block 10 includes a shoulder portion 40 (shown in FIG. 1). The shoulder portion 40, also referred to as counter-bore, is formed on the top deck 14 of the cylinder block 10. More specifically, the shoulder portion 40 is formed adjacent to the top end 20 of the bore 18.

The shoulder portion 40 includes an abutment surface 44 (shown in FIG. 3). The abutment surface 44 is defined by a first abutment surface 46 and a second abutment surface 48. In an example, the shoulder portion 40 may be formed by removing wore-out, corroded, and/or eroded surface of the cylinder block 10 by using a machining process. The machining process may include, but is not limited to, boring, milling or any other material removing process known in the art. The shoulder portion 40 of the cylinder block 10 is adapted to receive an insert 42 therein. Dimensional characteristics, such as width, length, and depth, of the shoulder portion 40 may vary based on various parameters, such as an amount of corroded or wear-out surface exist in proximity of the bore 18.

The cylinder block 10 also includes the insert 42 disposed in the shoulder portion 40 of the cylinder block 10. The insert 42 is welded to the shoulder portion 40 of the cylinder block 10 by means of resistance welding. In an example, the insert 42 may be made of cast iron, steel, or any other material known in the art. The insert 42 has a substantially annular shape and generally square shaped cross-section. The insert 42 includes an outer surface 50 (shown in FIG. 1) defined by a first surface 52, a second surface 54, a third surface 56, and a fourth surface 58. The outer surface 50 is adapted to fuse with the abutment surface 44 of the shoulder portion 40.

As shown in FIG. 3, the first surface 52 supports the flange portion 30 of the cylinder liner 26. More specifically, the first surface 52 of the insert 42 abuts the second annular surface 34 of the cylinder liner 26. The third surface 56 abuts the first abutment surface 46 of the shoulder portion 40. Further, the second surface 54 abuts the second abutment surface 48 of the shoulder portion 40. The fourth surface 58 of the insert 42 and the surface 36 of the cylinder liner 26 receive a sealing liner 60, also referred to as filler band, therebetween. The sealing liner 60 is provided to restrict leakage/flow of the fluid from the cavities 19 to the top deck 14 of the cylinder block 10.

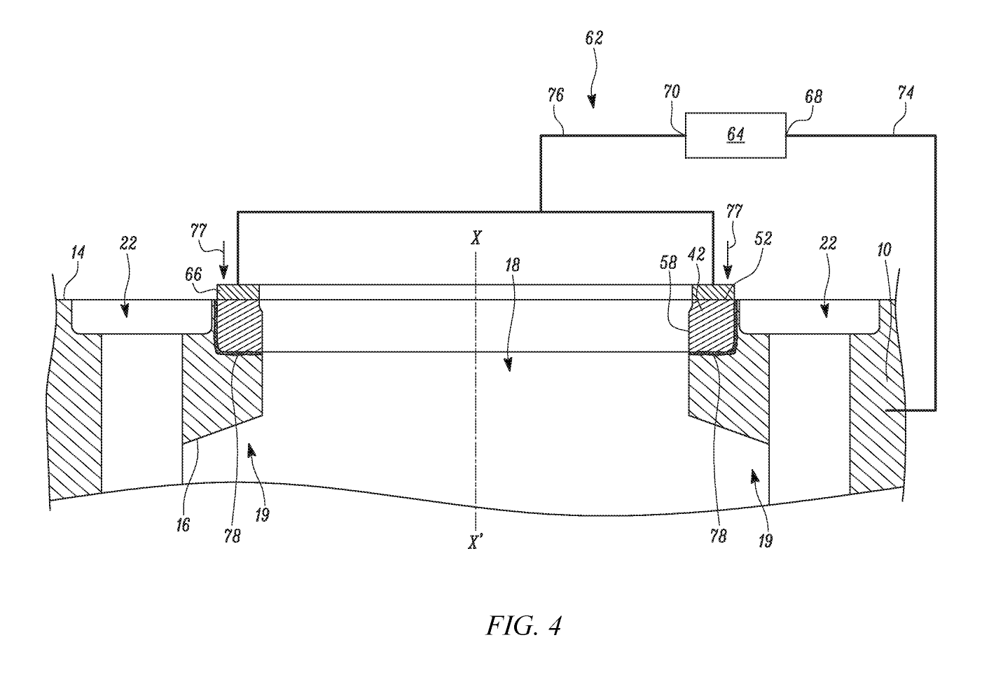

Referring to FIG. 4, a joining device 62 is connected to the insert 42 and the cylinder block 10. The joining device 62 is adapted to connect the insert 42 and the cylinder block 10. More specifically, the joining device 62 is provided for performing a welding process, such as a resistance welding process, to fuse the insert 42 with the cylinder block 10 of the engine 12. Further, the joining device 62 is provided to apply a predetermined force and a predetermined electric current on the insert 42. In one example, the predetermined force may be mechanically applied by the joining device 62 on the insert 42. In another example, the predetermined force may be hydraulically applied by the joining device 62 on the insert 42. In yet another example, the predetermined force may be pneumatically applied by the joining device 62 on the insert 42.

The joining device 62 includes a power source 64 and an electrode 66 connected to the power source 64. The power source 64 is provided to supply a predetermined electric current to the insert 42 through the electrode 66. The power source 64 includes a first terminal 68 and a second terminal 70. The first terminal 68 is connected to the cylinder block 10, via a first terminal connection 74. The second terminal 70 is connected to the electrode 66, via a second terminal connection 76. The electrode 66 is positioned on the insert 42 disposed in the shoulder portion 40 of the cylinder block 10. In an example, the electrode 66 may be made of copper or any other material known in the art. Operational characteristics, such as electrode material, shape, size, tip profile and cooling, of the electrode 66 may vary based on a material of the insert 42 and a material of the cylinder block 10.

As explained earlier, the insert 42 is placed within the shoulder portion 40 of the cylinder block 10 in a manner that the second surface 54 and the third surface 56 forms a contact with the second abutment surface 48 and the first abutment surface 46, respectively. In an example, the contact may be one of, but is not limited to, a surface contact.

As shown in FIG. 4, the electrode 66 of the joining device 62 is placed on the first surface 52 of the insert 42. During a welding process, the predetermined force and the predetermined electric current is applied to the insert 42 through the electrode 66 connected to the power source 64. The predetermined force and the predetermined electric current are applied to the insert 42 for fusing the outer surface 50 of the insert 42 with the abutment surface 44 of the shoulder portion 40.

The predetermined force applied to the insert 42 is selected based on the dimensional characteristics of the insert 42 and the predetermined electric current applied to the insert 42. In an example, the predetermined force may be in terms of pressure applied on the first surface 52 of the insert 42. In such an example, the pressure may be about 90 Megapascals. The predetermined force is applied on the insert 42 in a predefined direction 77 through the electrode 66. The predefined direction 77 is selected based on various parameters. The various parameters may include, but are not limited to, dimensional characteristics, such as shape, width, length, and height, of the insert 42. In an example, the predefined direction 77 of the predetermined force is a downward direction parallel to the longitudinal axis X-X′ of the bore 18.

Further, the predetermined electric current applied to the insert 42 is selected based on the material of the insert 42 and the material of the cylinder block 10. In an example, the predetermined electric current may be in a range of 10 amperes to 100000 amperes. The predetermined electric current and the predetermined force are applied to the insert 42 in a manner that surfaces, such as the second surface 54, the third surface 56, the first abutment surface 46, and the second abutment surface 48, of the insert 42 and the shoulder portion 40 fuse together to form a fused portion 78. More specifically, the second surface 54 and the third surface 56 fused with the second abutment surface 48 and the first abutment surface 46, respectively, to form the fused portion 78.

Due to the predetermined electric current and the predetermined force, the insert 42 and the shoulder portion 40 are heated to melting or near melting temperature in the vicinity of contact points on contact surfaces, such as the second surface 54, the third surface 56, the first abutment surface 46, and the second abutment surface 48, of the insert 42 and the shoulder portion 40. Subsequently, cooling at the contact surfaces, such as the second surface 54, the third surface 56, the first abutment surface 46, and the second abutment surface 48, the fused portion 78 is formed between the insert 42 and the cylinder block 10. In an example, the contact, such as a surface contact, between the third surface 56 and the first abutment surface 46 is less than the contact between the second surface 54 and the second abutment surface 48. In such an example, during welding process, the predetermined force may be applied in the predefined direction 77 in a manner that only the second surface 54 of the insert 42 and the second abutment surface 48 of the shoulder portion 40 are fused together to form the fused portion 78.

### INDUSTRIAL APPLICABILITY

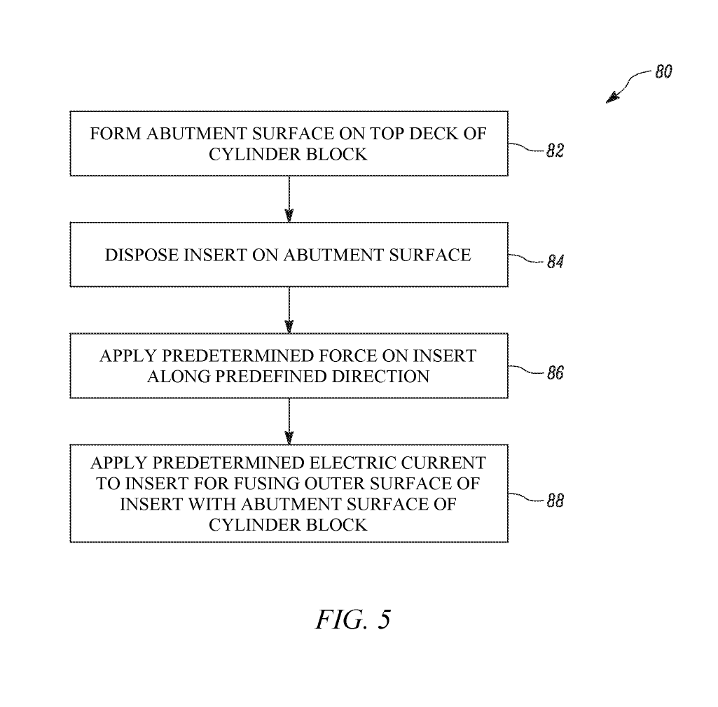

The present disclosure relates to the cylinder block 10 for the engine 12. FIG. 5 is a flowchart depicting a method 80 for remanufacturing the cylinder block 10, according to an embodiment of the present disclosure. For the sake of brevity, the aspects of the present disclosure which are already explained in detail in the description of FIG. 1, FIG. 2, FIG. 3, and FIG. 4 are not explained in detail with regard to the description of the method 80.

At block 82, the method 80 includes forming the abutment surface 44 on the top deck 14 of the cylinder block 10. The abutment surface 44 is formed adjacent to the top end 20 of the bore 18. In an example, the abutment surface 44 may be formed by the machining process, such as the milling process, the boring process, or any other process known in the art. Dimensional characteristics of the abutment surface 44 may be selected based on the amount of corroded or worn-out surface exist in proximity of the bore 18.

At block 84, the method 80 includes disposing the insert 42 on the abutment surface 44. The insert 42 is positioned within the shoulder portion 40 of the cylinder block 10. More specifically, the insert 42 is positioned with the shoulder portion 40 in a manner that the outer surface 50 of the insert 42 abuts the abutment surface 44 of the insert 42. In an example, the insert 42 is disposed within the shoulder portion 40 by applying an axial force in the downward direction parallel to the longitudinal axis X-X′.

At block 86, the method 80 includes applying the predetermined force on the insert 42 along the predefined direction 77. The predetermined force is transferred to the insert 42 through the electrode 66 of the joining device 62. The predetermined force applied to the insert 42 is selected based on the dimensional characteristics of the insert 42 and the predetermined electric current applied to the insert 42. At block 88, the method 80 includes applying the predetermined electric current to the insert 42 for fusing the outer surface 50 of the insert 42 with the abutment surface 44 of the cylinder block 10. The predetermined electric current is supplied to the insert 42 from the power source 64 through the electrode 66. The predetermined electric current applied to the insert 42 is selected based on operational parameters, such as the material of the insert 42 and the material of the cylinder block 10. Due to combination of the predetermined electric current and the predetermined force applied on the insert 42, the outer surface 50 of the insert 42 melts along with the abutment surface 44 of the cylinder block 10 to form the fused portion 78.

The insert 42 of the present disclosure can be welded to the cylinder block 10 of any type of internal combustion engine, such as a diesel engine or gas engine. Further, the method 80 of the present disclosure can be employed to weld the insert 42 to the cylinder block 10 of any type of internal combustion engine. In an example, the insert 42 can be employed in proximity to any bore, such as fastening bores or water ferrules, of the cylinder block 10. In an example, the insert 42 may be coupled to a portion of the cylinder block 10 in the vicinity of the water ferrules, such as the fluid passages 22. In such an example, a counter-bore (not shown) is formed in vicinity of each of the water ferrules for receiving the insert 42 therein. The insert 42 may be welded to the counter-bore in vicinity of the water ferrule using the joining device 62

The present disclosure offers simple, effective and economical method for remanufacturing the cylinder block 10. More specifically, the present disclosure offers effective and economical method of joining the insert 42 with the cylinder block 10. The insert 42 welded to the cylinder block 10 provides effective sealing between the top deck 14 of the cylinder block 10 and the cavities 19 between the cylinder liner 26 and the bore 18. The fused portion 78 is formed between the insert 42 and the cylinder block 10 eliminates any gap between the insert 42 and the cylinder block 10. Thus, the fused portion 78 formed between the insert 42 and the cylinder block 10 eliminates leakage of the fluid from the cavities 19 to the top deck 14 of the cylinder block 10. This protects the cylinder block 10 and the insert 42 from corrosion due to the fluid leakage from the cavities 19. Therefore, the cylinder block 10 and the insert 42 are effectively protected from corrosion leading to increased life of the cylinder block 10 and the engine 12.

What is claimed is:

1. A cylinder block of an engine, the cylinder block comprising:
a top deck;
a cylindrical surface defining a bore extending from the top deck along a longitudinal axis;
a shoulder portion formed on the top deck, and including an abutment surface; and
an insert disposed in the shoulder portion, the insert including an outer surface adapted to fuse with the abutment surface of the shoulder portion;
wherein a predetermined force and a predetermined electric current are applied to the insert for fusing the outer surface of the insert with the abutment surface of the shoulder portion.

2. The cylinder block of claim 1, wherein the bore is a cylinder bore of the engine, the cylinder bore is adapted to accommodate a cylinder liner.

3. A method of remanufacturing a cylinder block of an engine, the method comprising:
forming an abutment surface on a top deck of the cylinder block;
disposing an insert on the abutment surface;
applying a predetermined force on the insert along a predefined direction; and
applying a predetermined electric current to the insert for fusing an outer surface of the insert with the abutment surface of the cylinder block.
